(19) United States
(12) Patent Application Publication
(10) Pub. No.: US 2021/0002134 A1
(43) Pub. Date: Jan. 7, 2021

(54) METHOD AND DEVICE FOR PRODUCING CHLORINE DIOXIDE

(71) Applicant: ProMinent GmbH, Heidelberg (DE)

(72) Inventors: Matthias Rothe, Hockenheim (DE); Wolfgang Weibler, Heddesheim (DE)

(21) Appl. No.: 16/911,772

(22) Filed: Jun. 25, 2020

(30) Foreign Application Priority Data
Jul. 1, 2019 (DE) 10 2019 117 728.6

(51) Int. Cl. C01B 11/02; B01J 19/24; B01J 19/00; A01N 59/00

(52) U.S. Cl. CPC C01B 11/024; B01J 19/24; B01J 2219/00186; A01N 59/00; B01J 19/0006

(57) ABSTRACT

In order to provide a method with which the costs incurred in conventional methods for producing chlorine dioxide according to the chlorite-acid method can be significantly lowered, a method is proposed according to the invention, in which an acid, a chlorite and optionally water are introduced into a reactor, wherein in the method the reaction temperature in the reactor is determined and the quantity of acid, chlorite and/or water which is/are introduced into the reactor is chosen such that the acid introduced into the reactor is introduced into the reactor with a molar excess relative to the chlorite introduced into the reactor, wherein the level of the molar excess is varied with the level of the reaction temperature determined. In addition, the present invention relates to a device which is suitable for implementing the method according to the invention.

The present invention relates to a method for producing an aqueous solution of chlorine dioxide, in which an acid, a chlorite and optionally water are introduced into a reactor, wherein the acid introduced into the reactor is introduced into the reactor with a molar excess relative to the chlorite introduced into the reactor.

In addition, the present invention relates to a device for producing an aqueous solution of chlorine dioxide, wherein the device has a reactor, a first line for introducing an acid into the reactor, a second line for introducing a chlorite into the reactor and optionally a third line for introducing water into the reactor, wherein the device is suitable for implementing the method according to the invention.

At room temperature and atmospheric pressure chlorine dioxide (ClO₂) is a yellowish-reddish gas with disinfectant properties and with good solubility and stability in water. However, gaseous chlorine dioxide decomposes explosively in air from a concentration of 300 g/m³. Depending on the pressure and temperature, in an aqueous solution from a concentration of 30 g/l, liquid chlorine dioxide can precipitate, and it decomposes explosively.

The disinfectant action is stronger than that of chlorine and not dependent on the pH of the water. No undesired chlorinated disinfection byproducts form during use, and the taste and smell of the disinfected water are not negatively affected. Because of these advantages, among others, it is replacing the otherwise frequently used chlorine in ever more applications.

Chlorine dioxide is used in the field of communal drinking and waste water treatment, in industrial plants, at drinks manufacturers, in catering and hospitals, but also in residences, in order to achieve a reliable disinfection and sterilization of drinking, tap and process water. Chlorine dioxide is predominantly produced on site according to the chlorite-acid method or according to the chlorite-chlorine method with correspondingly designed chlorine dioxide systems.

The present invention relates to the chlorite-acid method, in which an aqueous solution of a chlorite is reacted with an acid to form chlorine dioxide (ClO₂) and a chloride.

The sodium chlorite-hydrochloric acid method, in which sodium chlorite (NaClO2) is reacted with hydrochloric acid (HCl) according to the reaction equation:

5NaClO₂+4HCl→4ClO₂+5NaCl+2H₂O

to form chlorine dioxide (ClO₂) and sodium chloride (NaCl), is widely used. Alternatively, the chlorite-acid method can also be carried out with other acids, such as e.g. sulfuric acid, and also with other chlorites, such as e.g. potassium chlorite.

Disinfection by means of chlorine dioxide is made possible by chlorine dioxide systems the mode of operation of which is prescribed in regulations (DVGW worksheets W 224 and W 624), such as e.g. from the DVGW (German Technical and Scientific Association for Gas and Water). According to guidelines in these regulations, for the reaction of a sodium chlorite solution with hydrochloric acid an at least three-fold excess of hydrochloric acid compared with the chlorite is named in order to guarantee the stoichiometric yield of chlorine dioxide of at least 85% necessary for a reliable disinfection. A little more precisely, an acid addition of at least three times the stoichiometric excess is named according to DVGW worksheet W 224, meaning that at least 2.4 moles of acid is to be used per mole of chlorite. In order also to achieve a high yield under all operating conditions, such as for example temperature and utilized capacity of the system, in practice a three-fold molar excess has become established, meaning that in practice usually three moles of acid is used per mole of chlorite (R=3). This corresponds to a stoichiometric excess of 375% according to the above-mentioned reaction equation. The three-fold molar excess is achieved e.g. if the concentrations of the chemicals mentioned in the DVGW worksheets and made up in advance in a manner customary in the trade of 9% hydrochloric acid and 7.5% sodium chlorite solution are used in a volume ratio of 1:1.

In the treatment of communal drinking water and waste water as well as in industrial applications, large quantities of water must be disinfected or sterilized, and the chemicals which have to be used for these purposes represent a substantial cost factor. There is therefore a need for methods and devices which can be implemented or operated with lower costs.

Against this background, the object of the present invention is, among other things, to provide a method with which the costs incurred in conventional methods for producing chlorine dioxide according to the chlorite-acid method can be lowered significantly. At the same time, a device is to be provided with which such a method can be implemented.

This object is achieved according to the invention by a method for producing an aqueous solution of chlorine dioxide in which an acid, a chlorite and optionally water are introduced into a reactor, wherein in the method the reaction temperature in the reactor is determined and the quantity of acid, chlorite and/or water which is/are introduced into the reactor is chosen such that the acid introduced into the reactor is introduced into the reactor with a molar excess relative to the chlorite introduced into the reactor, wherein the level of the molar excess is varied with the level of the reaction temperature determined.

In practice, chlorine dioxide capacities of 4 kg/h are not rare, such as e.g. in the case of applications in the treatment of industrial process water and cooling water for the sterilization of the process water and cooling water. According to the inventors' calculations, in the operation of a chlorine dioxide system with this capacity the costs of the chemicals used (sodium chlorite and hydrochloric acid in the calculation example) per year can be reduced by approximately 40,000 EUR per year, without in the process falling below the target yield of ≥85% chlorine dioxide, by reducing the acid quantity from R=3 (three moles of acid per mole of chlorite) to R=2 (two moles of acid per mole of chlorite).

According to the invention, this is achieved in that the reaction temperature in the reactor in which the acid is reacted with the chlorite is determined and the molar excess of the acid relative to the chlorite in the reactor is chosen such that the level of the molar excess is varied with the level of the reaction temperature determined. The basis for this is that the inventors have found that smaller molar excesses of acid than the three-fold molar excess stipulated in the DVGW worksheets are necessary at lower reaction temperatures. However, if there are higher reaction temperatures in the reactor, the three-fold molar excess stipulated by the DVGW is actually necessary in order to achieve a yield of at least 85% chlorine dioxide.

The method according to the invention can in principle be carried out non-continuously or continuously. The “chlorites” used here are salts of chlorous acid and preferably selected from sodium chlorite (NaClO₂) and potassium chlorite (KClO₂).

The term “acid” within the meaning of the present invention includes in particular inorganic acids, such as e.g. hydrochloric acid (HCl) and sulfuric acid (H₂SO₄). The present invention also includes those embodiments in which the acid is added in the form of one of its salts, e.g. in the form of sodium hydrogen sulfate (NaHSO₄).

The method according to the invention is implemented in a “reactor”. This is a chemical reactor with a reactor vessel, in which the reaction mixture which is formed of acid, chlorite and optionally water can react. The reactor vessel has a reactor interior which is enclosed by a reactor vessel wall and in which the reaction mixture is present during operation.

The “reaction mixture” forms due to the introduction of the educts acid and chlorite into the reactor interior. The mixing is preferably effected by vortex mixing and in particular embodiments can be accelerated, e.g. by introducing the educts and optionally water into the reactor with sharp metering strokes.

The term “reaction temperature” within the meaning of the present invention is given to denote the temperature which is present in the reactor vessel or, more precisely, in the reactor interior or, still more precisely, in the reaction mixture. Typically, the reaction temperature in the method according to the invention lies in the range of from 5 to 50° C. In particular embodiments the reaction temperature lies in the range of from 5 to 45° C., in the range of from 10 to 50° C. or in the range of from 10 to 40° C.

In the case of the present invention the term “molar excess” refers to the ratio of the acid introduced into the reactor to the chlorite introduced into the reactor. This means that with a ratio of one mole of acid to one mole of chlorite there is no molar excess (R=1). However, if for example 1.5 moles of acid, 2 moles of acid or even 3 moles of acid is added per mole of chlorite, then the acid introduced into the reactor and mixed with the chlorite is present with a 1.5-fold molar excess (R=1.5), with a two-fold molar excess (R=2) or even with a three-fold molar excess (R=3) relative to the chlorite introduced into the reactor.

It is worth bearing in mind here that the term “molar excess” is not synonymous with the term “stoichiometric excess”. Starting from the above-mentioned reaction equation for the reaction of sodium chlorite with hydrochloric acid to form chlorine dioxide, sodium chlorite and water, a three-fold molar acid excess corresponds to a stoichiometric excess of 375%.

According to the invention, the molar excess of the acid relative to the chlorite can lie in the range of from R=1.5 to 4.0. In particular embodiments the molar excess lies in the range of from R=2.0 to 4.0, in the range of from R=2.5 to 4.0, in the range of from R=2.5 to 3.0, in the range of from R=2.5 to 3.5 or in the range of from R=2.5 to 3.0.

In a specific embodiment of the present invention the acid introduced into the reactor is introduced into the reactor at a reaction temperature determined in the range of from 10 to 40° C. with a molar excess in the range of from R=2.0 to 3.5 relative to the chlorite introduced into the reactor.

In a preferred embodiment of the invention the level of the molar excess of the acid introduced into the reactor relative to the chlorite introduced into the reactor increases with the level of the reaction temperature. In particular embodiments this increase takes place continuously. In other embodiments of the invention the increase takes place incrementally. In specific embodiments of the invention the increase takes place partially continuously and partially incrementally.

In the embodiments of the invention in which the level of the molar excess increases with the level of the reaction temperature partially or entirely continuously, the molar excess (R) which is present at a particular reaction temperature (T) is preferably determined according to the formula

R=2.0+0.05×(T−10)+/−0.5

In the embodiments of the method according to the invention in which the level of the molar excess increases with the level of the reaction temperature partially or entirely incrementally, one or more of the following increments can be provided:
At a reaction temperature in the range of from 10 to <25° C. the molar excess lies in the range of from R=2.0 to 2.5.
At a reaction temperature in the range of from 25 to 30° C. the molar excess lies in the range of from R=2.5 to 3.0.
At a reaction temperature in the range of from >30 to 40° C. the molar excess lies in the range of from R=3.0 to 3.5.

In particular embodiments of the invention the increments are distributed such that at a reaction temperature which is <30° C., <29° C., <28° C., <27° C. or <25° C. the molar excess is R=2.5 optionally with a tolerance range of +/−0.2. At a reaction temperature of >30° C., >29° C., >28° C., >27° C., >26° C. or >25° C. the molar excess is R=3.0 optionally with a tolerance range of +/−0.2.

According to the invention the reaction temperature can be determined in various ways. Either the reaction temperature is determined directly using the temperature measured in the reactor interior or in the reaction mixture, for example with a temperature sensor which is arranged with corrosion protection in the reactor vessel and is protected from the reaction mixture e.g. with a titanium sleeve.

In an alternative embodiment the reaction temperature is determined using the temperature measured on the outer wall of the reactor vessel. In further alternative embodiments the temperature of the educts acid, chlorite and/or water which are introduced into the reactor is measured either on the line via which the introduction is effected or in a container from which the educts are taken or on the container wall thereof. As the heat of reaction in the production of chlorine dioxide according to the chlorite-acid method is relatively low and for a heating of the reaction mixture lies in the range of from 1 to 2° C. compared with the temperature of the educts used, the reaction temperature present in the reaction mixture can also be determined very precisely in this way.

In a specific embodiment the temperature of the air in the environment in which the method is implemented is determined, if the containers from which the educts of the reaction are taken are located in the same environment. It is assumed here that the educts stored in this environment in the containers have substantially the same temperature as the environment itself, with the result that the reaction temperature in the reactor can be determined directly from it.

In particular embodiments of the invention the molar excess of the acid relative to the chlorite is varied depending on the duration of the reaction time as well as depending on the level of the reaction temperature.

The “reaction time” here corresponds to the residence time of the reaction mixture produced from the educts in the reactor. The reaction time can lie in the range of from 1 to 100 minutes. In particular embodiments the reaction time lies in the range of from 1 to 40 minutes or in the range of from 4 to 40 minutes. In alternative embodiments the reaction time lies in the range of from 1 to 30 minutes or in the range of from 4 to 30 minutes.

In a specific embodiment of the present invention the acid is introduced into the reactor with a molar excess relative to the chlorite in the range of from 2.0 to 3.5, wherein the value of the molar excess increases with the duration of the reaction time from a reaction time of 20 minutes, from a reaction time of 30 minutes or from a reaction time of 40 minutes.

In further specific embodiments of the invention the level of the molar excess (R) lies in one or more of the following ranges:
With a reaction time in the range of from 1 to <4 minutes the level of the molar excess lies in the range of from R=2.0 to 2.5.
With a reaction time in the range of from 4 to 30 minutes the level of the molar excess lies in the range of from R=2.5 to 3.0.
With a reaction time in the range of from >30 to 40 minutes the level of the molar excess lies in the range of from R=3.0 to 3.5.

In particular embodiments of the present invention either hydrochloric acid or sulfuric acid is used as acid. In the embodiments in which hydrochloric acid is used, either concentrated hydrochloric acid with a concentration in the range of from 25 to 36 wt.-% or dilute hydrochloric acid with a concentration in the range of from 3 to 6 wt.-% can be used.

In specific embodiments of the present invention the chlorite used is an aqueous solution of sodium chlorite or potassium chlorite. In specific embodiments of the invention the concentration of sodium chlorite or potassium chlorite in the aqueous solution lies in the range of from 20 to 30 wt.-%.

According to the guidelines of the DVGW a minimum stoichiometric yield of chlorine dioxide of 85% is to be guaranteed. In the method according to the invention this is realized in that the molar excess of acid is varied depending on the reaction temperature and/or depending on the reaction time. In particular embodiments of the invention a minimum stoichiometric yield of 87% or even a minimum yield of 90% is achieved through this control. In preferred embodiments of the invention the yield achieved with the method lies in the range of from 90 to 95%. In this way it is ensured that the minimum yield required by the DVGW of 85% is always safely and reliably met.

The present invention also includes a “chlorine dioxide system”, thus a device for producing an aqueous solution of chlorine dioxide, wherein the device has a reactor, a first line for introducing an acid into the reactor, a second line for introducing a chlorite into the reactor and optionally a third line for introducing water into the reactor, wherein the device is characterized in particular in that it has an apparatus for determining the reaction temperature in the reactor and a control unit for controlling the flow of acid, chlorite and/or water via the first, second and/or third line into the reactor. The control unit is set up such that the acid introduced into the reactor is introduced into the reactor with a molar excess relative to the chlorite introduced into the reactor, wherein this molar excess varies with the level of the reaction temperature.

The “reactor” used according to the invention is a chemical reactor with a reactor vessel, in which the reaction mixture which is formed of acid, chlorite and optionally water can react. The reactor vessel has a reactor vessel wall, which encloses the reactor interior in which the reaction mixture is present during operation. At least one inlet, via which the educts of the chlorite-acid reaction and optionally water can be introduced into the reactor interior, is provided in the reactor vessel wall.

The chlorine dioxide system according to the invention is set up such that the method according to the invention can be implemented with it. In the embodiments in which the method according to the invention is conducted non-continuously the reactor is preferably a mixing vessel for batch operation. In the vast majority of cases, however, the method according to the invention is conducted continuously, and in the embodiments of the chlorine dioxide system in which this is the case the reactor is preferably a flow reactor.

The educts and optionally water are fed into the reactor via lines. These are pipelines which are connected to a source for the educts and optionally water.

In particular embodiments a metering pump, via which the metering of at least one of the educts and optionally the water can be effected, is arranged on at least one of the lines. Preferably, one metering pump is provided for the acid, one metering pump for the chlorite and optionally one metering pump for the water.

In particular embodiments a valve, via which the flow volume of at least one of the educts and optionally the water can be altered, is arranged on at least one of the lines and/or on the reactor. Preferably, one valve is provided for the acid, one valve for the chlorite and optionally one valve for the water.

In particular embodiments a flow control, with which the flow volume of at least one of the educts and optionally the water can be monitored, is arranged on at least one of the lines and/or on the reactor.

Via the control provided according to the invention for the quantity of acid introduced into the reactor, the level of the acid excess can be set directly in the reactor. Alternatively, the level of the acid excess can also be effected by controlling the quantity of chlorite introduced.

Alternatively or additionally, the method can also be controlled via the addition of water to the reactor. Via this, the effective reaction volume of the reaction mixture can be set. Moreover, the introduction of additional water can ensure that the maximum concentration of chlorine dioxide of 30 g/l is not exceeded. Finally, the desired concentration of chlorine dioxide can even be set very precisely in this way, such as e.g. a target concentration of 20 g/l. In addition, the reaction can also be stopped by dilution through the supply of larger quantities of water. In particular in the case of low system output, the residence time at high concentration in the reactor is thereby reduced and the stability of the chlorine dioxide solution obtained is thereby increased.

The control is effected via a control unit in the chlorine dioxide system according to the invention. This is an electronic unit in which electronic data are stored which define what molar excess (R) is to be set at what temperature and with what reaction time in order to achieve the desired chlorine dioxide yield. For this, the control unit has at least one signal input and at least one signal output, via which signals can be received and sent via wires or wirelessly.

In particular, the control unit has a signal input for signals from the apparatus for determining the reaction temperature. Optionally, the control unit additionally has another signal input for signals from one or more flow controls,

Moreover, the control unit has in particular a signal output for a signal for controlling the quantity of acid and/or chlorite and optionally water which is introduced into the reactor. This signal for controlling the quantity of acid and/or chlorite and optionally water can be sent for example to the respective valve, via which the flow volume of at least one of the educts and optionally the water can be altered, or to the corresponding metering pumps.

The apparatus provided in the chlorine dioxide system according to the invention for determining the reaction temperature is a measuring device for determining the temperature, in particular a thermometer, the temperature sensor of which is arranged either in the reactor interior, on the outer wall of the reactor vessel, on the line via which the introduction of one of the educts or water is effected, in a container from which the educts or the water are taken, on the wall of the container from which the educts or the water are taken, or in the space where the system is situated.

For the purposes of the original disclosure, it is pointed out that all features as revealed to a person skilled in the art from the present description, the drawings and the claims, even if they were described specifically only in connection with particular further features, can be combined both individually and in any combinations with others of the features or groups of features disclosed here, unless this was explicitly ruled out or technical circumstances make such combinations impossible or pointless. The comprehensive, explicit representation of all conceivable combinations of features is dispensed with here merely for the sake of the brevity and readability of the description.

In addition, it is pointed out that it is self-evident to a person skilled in the art that the following embodiment examples merely serve to indicate by way of example the possible embodiments of the present invention reproduced as embodiment examples. A person skilled in the art will therefore immediately understand that all other embodiments which have the features or combinations of features according to the invention named in the claims moreover also lie within the scope of protection of the invention. The comprehensive, explicit representation of all conceivable embodiments is dispensed with here merely for the sake of the brevity and readability of the description.

To demonstrate the advantages connected with the present invention, reference is made to the attached figures. There are shown in:

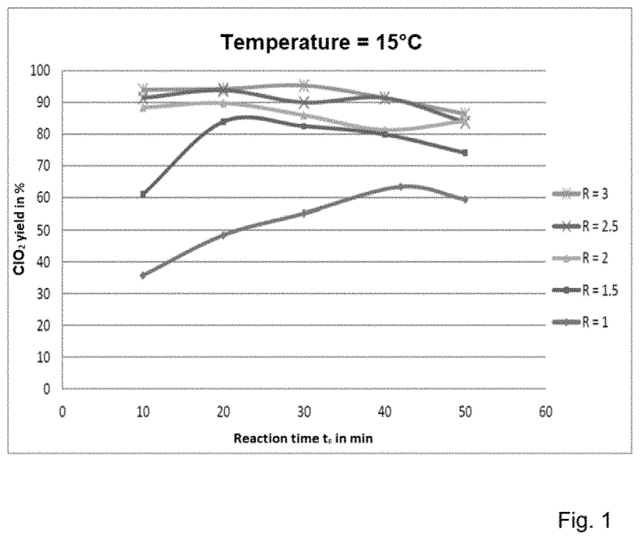

FIG. 1: the stoichiometric chlorine dioxide yield at a reaction temperature of 15° C. with different reaction times and when a molar acid excess in the range of from R=1 to 3 is used,

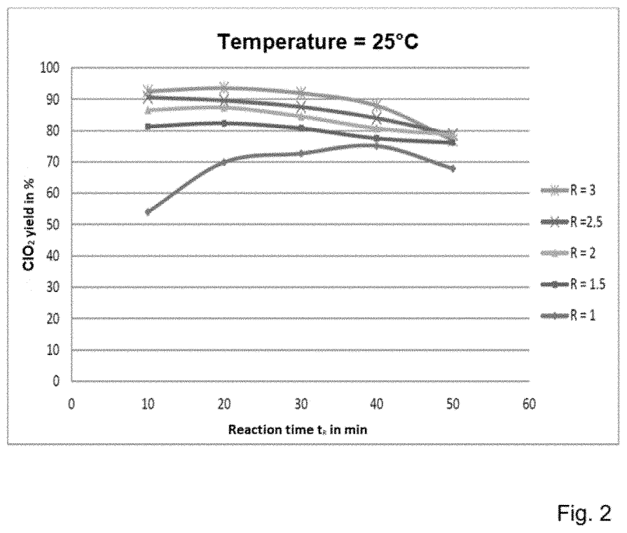

FIG. 2: the stoichiometric chlorine dioxide yield at a reaction temperature of 25° C. with different reaction times and when a molar acid excess in the range of from R=1 to 3 is used,

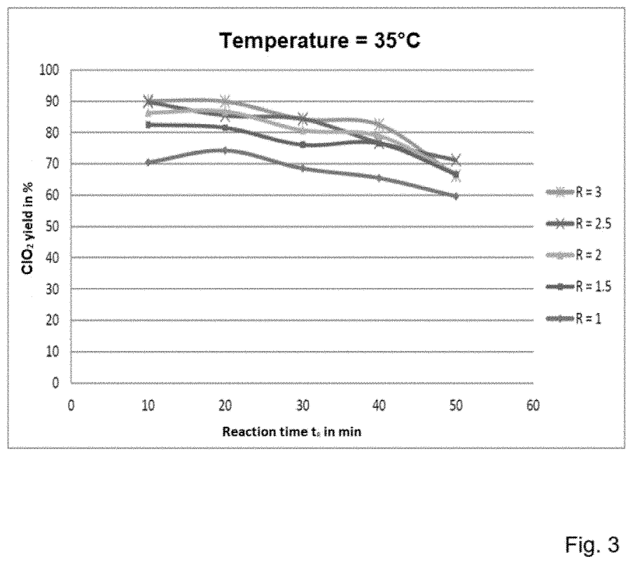

FIG. 3: the stoichiometric chlorine dioxide yield at a reaction temperature of 35° C. with different reaction times and when a molar acid excess in the range of from R=1 to 3 is used, and

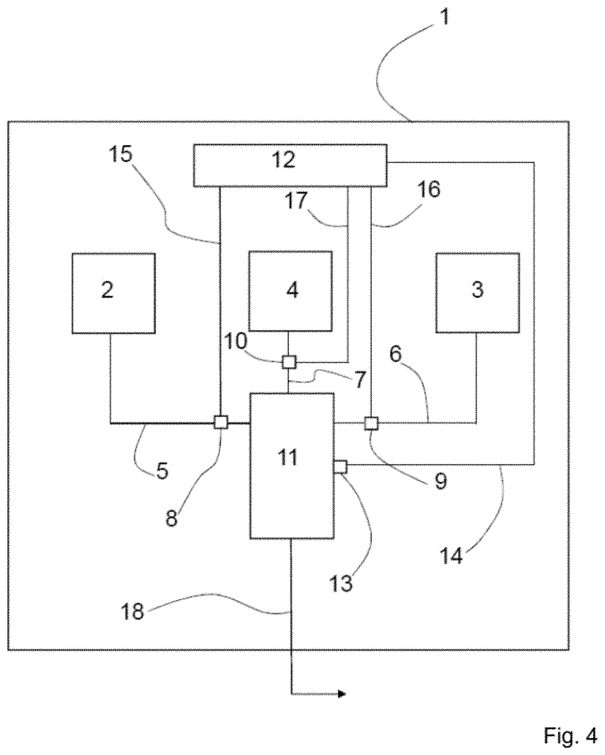

FIG. 4: a schematic representation of a particular embodiment of the device according to the invention for producing an aqueous solution of chlorine dioxide.

### EXAMPLES

In order to investigate the influence of the quantities of chlorite and acid used as well as the influence of the reaction temperature and the reaction time on the yield of chlorine dioxide, laboratory tests were carried out. For this, a gas-tight glass syringe with a volume of 25 ml was used, which acts as the reactor in the laboratory approach. A PTFE stopper was used to seal the syringe, with the result that the syringe with its contents can be incubated in a water bath. The gas-tight glass syringe is to be regarded as a batch reactor, in which a 5-ml chlorine dioxide sample can be taken at a particular time point (reaction time).

In the laboratory test hydrochloric acid with a concentration of 9 wt.-% was used as acid. The chlorite was provided in the form of an aqueous sodium chlorite solution with a concentration of 7.5 wt.-%. These concentrations are chosen such that when mixed together in identical volumes the hydrochloric acid is present in a three-fold molar excess relative to the chlorite. In order to achieve a smaller molar excess or even an equimolar ratio (R=1), the hydrochloric acid solution used must be diluted correspondingly.

The quantitative determination of the chlorine dioxide produced is effected iodometrically.

The curves represented in FIG. 1 show that at a reaction temperature of 15° C. the yield of chlorine dioxide increases with a higher molar acid ratio relative to the chlorite used. With an increasing acid ratio, the reaction rate also increases, which is to be recognized in the shift of the peak from a molar excess of R=1.5. Over wide ranges of the reaction time the required chlorine dioxide yields of at least 85% (stoichiometric) are not achieved with molar excesses in the range of from R=1 to 2. This is only guaranteed from a molar excess of R=2.5.

It is to be recognized from the curves represented in FIG. 2, which show the results at a reaction temperature of 25° C., that with reaction times between 10 and 30 minutes in principle a molar acid ratio of R=2 would be sufficient in order to obtain a yield of 85% and more. With a molar excess of R=2.5, this is also still possible with a reaction time of up to 40 minutes.

It can be read from the curves of FIG. 3, which reflect the ratios at a reaction temperature of 35° C., that yields of at least 85% can be reliably achieved with a reaction time of up to 40 minutes only with a molar excess R=3.

It can be seen from the present results that at temperatures of 15° C. and 25° C. and with a reaction time of from 10 to 30 minutes a molar acid ratio of R=2 can be used in order to achieve a yield of at least 85%, as is required by the DVGW worksheets. However, should the reaction time be longer than 30 minutes, at reaction temperatures of 15° C. and 25° C. at least an acid ratio of R=2.5 must be used in order to stabilize the required yield of 85% and not to reduce it through the chlorine dioxide decomposition starting in an intensified manner at these temperatures. At a reaction temperature of 35° C. and with a reaction time of from 10 to 20 minutes, a molar acid ratio of R=2 can be sufficient in order to achieve the required yield. However, if the reaction times become greater than 20 minutes, an acid ratio of R=3 is necessary in order to compensate for the chlorine dioxide decomposition.

FIG. 4 shows a schematic representation of a specific embodiment of a chlorine dioxide system 1 according to the invention for producing chlorine dioxide. In this chlorine dioxide system 1 a container 2 for the acid, a container 3 for the chlorite and a container 4 for water are provided. In an alternative embodiment of the present invention the device has no container 4 for water.

The containers 2, 3 and 4 for acid, chlorite and water are connected to the reactor 11 via pipelines 5, 6 and 7, in order to be able to introduce the respective fluid into the reactor vessel. In the embodiment without water container 4 no line 7 for the water is provided either.

In the embodiment represented here valves 8, 9 and 10, via which the flow of fluid through the lines 5, 6 and 7 can be altered, are provided on the lines 5, 6 and 7. The control of the valves 8, 9 and 10, and thus the control of the flow volumes, is effected via the control unit 12, which is connected to the respective valve 8, 9 or 10 via signal lines 15, 16 and 17. In an alternative embodiment of the present invention, instead of the valves represented, other metering apparatuses are used, such as e.g. metering pumps.

A thermometer 13, which measures the temperature on the outer wall of the reactor vessel in the embodiment represented here and transmits the measured temperature to the control unit 12 via the signal line 14, is provided on the reactor 11.

In the control unit 12, the molar excess (R) of acid necessary for the necessary minimum yield of 85% chlorine dioxide is determined using the reaction temperature measured by the thermometer 13, and the metering of acid and/or chlorite and/or water (if a water container 4 is present) is controlled accordingly via the valves 8, 9 and/or 10. The reaction time, which depends on the capacity at which the chlorine dioxide system 1 is run at the given time point, is also taken into account here.

The chlorine dioxide solution produced by the chlorine dioxide system 1 in the reactor 11 is conducted via the outlet 18 to where the chlorine dioxide solution is to be used.

### LIST OF REFERENCE NUMBERS

1 device for producing chlorine dioxide (chlorine dioxide system)
2 container for acid
3 container for chlorite
4 container for water
5 line for acid
6 line for chlorite
7 line for water
8 valve for acid
9 valve for chlorite
10 valve for water
11 reactor
12 control unit
13 thermometer
14 signal line for temperature
15 signal line for acid flow
16 signal line for chlorite flow
17 signal line for water flow
18 outlet for chlorine dioxide solution

1. Method for producing an aqueous solution of chlorine dioxide in which an acid, a chlorite and optionally water are introduced into a reactor, characterized in that in the method the reaction temperature in the reactor is determined and the quantity of acid, chlorite and/or water which is/are introduced into the reactor is chosen such that the acid introduced into the reactor is introduced into the reactor with a molar excess relative to the chlorite introduced into the reactor, wherein the level of the molar excess is varied with the level of the reaction temperature determined.

2. Method according to claim 1, characterized in that the acid introduced into the reactor is introduced into the reactor at a reaction temperature determined in the range of from 10 to 40° C. with a molar excess in the range of from 2.0 to 3.5 relative to the chlorite introduced into the reactor.

3. Method according to claim 1, characterized in that the level of the molar excess increases with the level of the reaction temperature.

4. Method according to claim 1, characterized in that the level of the molar excess
at a reaction temperature in the range of from 10 to <25° C. lies in the range of from 2.0 to 2.5,
at a reaction temperature in the range of from 25 to <30° C. lies in the range of from 2.5 to 3.0 and
at a reaction temperature in the range of from 30 to <40° C. lies in the range of from 3.0 to 3.5.

5. Method according to claim 1, characterized in that the reaction temperature is determined using the temperature in the reactor, on the reactor outer wall, on a line for introducing acid, chlorite and/or water into the reactor, in a container from which acid, chlorite and/or water to be introduced into the reactor are kept or on the container wall thereof or in the air in the environment in which the method is implemented.

6. Method according to claim 1, characterized in that the molar excess is varied depending on the duration of the reaction time as well as depending on the level of the reaction temperature.

7. Method according to claim 6, characterized in that the acid is introduced into the reactor with a molar excess in the range of from 2.0 to 3.5 relative to the chlorite with a reaction time in the range of from 1 to 100 minutes, wherein the value of the molar excess becomes greater with the duration of the reaction time from a reaction time of 20 minutes.

8. Method according to claim 1, characterized in that the level of the molar excess
with a reaction time in the range of from 1 to <4 minutes lies in the range of from 2.0 to 2.5,
with a reaction time in the range of from 4 to 30 minutes lies in the range of from 2.5 to 3.0 and
with a reaction time in the range of from >30 to 40 minutes lies in the range of from 3.0 to 3.5.

9. Method according to claim 1, characterized in that the acid is selected from the group consisting of sulfuric acid and hydrochloric acid.

10. Method according to claim 1, characterized in that the chlorite is an aqueous solution of selected from the group consisting of potassium chlorite and sodium chlorite.

11. Device (1) for producing an aqueous solution of chlorine dioxide, wherein the device has a reactor (11), a first line (5) for introducing an acid into the reactor (11), a second line (6) for introducing a chlorite into the reactor (11) and optionally a third line (7) for introducing water into the reactor (11), characterized in that the device has an apparatus (13) for determining the reaction temperature in the reactor (11) and a control unit (12) for controlling the flow of acid, chlorite and/or water via the first, second and/or third line (5, 6, 7) into the reactor (11), wherein the control unit (12) is set up such that the acid introduced into the reactor (11) is introduced into the reactor (11) with a molar excess relative to the chlorite introduced into the reactor (11), wherein the molar excess varies with the level of the reaction temperature.

12. Device according to claim 11, characterized in that the device (1) implements a method according to claim 1.

13. Device according to claim 11, characterized in that the reactor (11) is a flow reactor.

14. Device according to claim 11, characterized in that the device has at least one of the following apparatuses: a metering pump for the acid, a metering pump for the chlorite, a metering pump for the water, a valve (8, 9, 10) on the first, second and/or optional third line (5, 6, 7), a flow control on the first, second and/or optional third line, a container (2, 3, 4) for the acid, for the chlorite and/or optionally for water.
